(19) United States
(12) Patent Application Publication
(10) Pub. No.: US 2021/0118330 A1
(43) Pub. Date: Apr. 22, 2021

(54) PERSONALIZED DRIVER COACHING

(71) Applicant: LINKEDRIVE, INC., Natick, MA (US)

(72) Inventors: Jeffrey C. Baer, Dover, MA (US); Tibor F. Ivanyi, Pelham, NH (US); Sergey L. Eidelman, Bolton, MA (US); Chad M. Kosterman, Nashua, NH (US)

(21) Appl. No.: 17/005,627

(22) Filed: Aug. 28, 2020

Related U.S. Application Data
(60) Provisional application No. 62/924,063, filed on Oct. 21, 2019.

(51) Int. Cl. G09B 19/16; G07C 5/08; G06Q 50/26; G01C 21/34; G01C 21/36; G06F 40/40; G06F 40/205; G08G 1/0967

(52) U.S. Cl. CPC G09B 19/167; G07C 5/08; G06Q 50/265; G01C 21/3469; G06Q 30/018; G01C 21/3641; G06F 40/40; G06F 40/205; G08G 1/0967; G01C 21/3492

(57) ABSTRACT

A method and system for automatically generating driver coaching messages that reflect the driver's immediate past 2 week's performance along related to actual vehicle performance during that same period utilizing actual coaching messages previously evaluated and stored.

### CROSS REFERENCE TO RELATED APPLICATIONS

This application claims the benefit of priority of U.S. Provisional Patent Application Ser. No. 62/924,063, filed Oct. 21, 2019, which is incorporated by reference herein in its entirety.

### BACKGROUND

### Technical Field

This disclosure relates generally to applications and methods that may be implemented in or using a mobile device to teach, measure and reward motor vehicle drivers to operate their vehicles in a fuel-efficient and safe manner.

### Background of the Related Art

Mobile devices, such as a smartphone or tablet, have become ubiquitous in today's society. Faster processors, more memory, higher quality gesture-based multi-touch screens, availability of mobile broadband data, and integration of multi-media and GPS chips along with open interface mobile operating systems, have opened the door for creation of a large variety of mobile applications. One such mobile application is a driver coaching application. In particular, and using a technique such as described in U.S. Pat. No. 9,135,759, a driver of a vehicle can use his or her mobile device to facilitate collection and display of real-time performance information to the driver, e.g., to facilitate more efficient fuel usage and economy.

Currently coaching today is based on detection of undesirable behavior and basically telling the driver “don't do that”. Whether this is automated via a computer picking a coaching message based on some telemetric measurement or done by an actual fleet manager, this is what is done. For example, if the driver braked hard too many times in the previous work cycle, tell him/her “Don't brake hard.” What is needed is a mechanism that provides a driver with highly specific messages that reflect on what the driver did before. This is a key to effective automated coaching. Further, what is needed is a method for evaluating past performance, generating coaching statements that reflect past performance and providing a more effective emulation of coaching that would be done by a human coach.

### SUMMARY OF THE DISCLOSURE

The present disclosure focuses on examination of prior performance records of driver performance in order to formulate prospective coaching messages. Once such coaching messages are generated, they are parsed into meta-data and each associated with a category in accordance with predetermined criteria and stored in a database for later retrieval and comparison to generate new coaching messages.

An exemplary method for producing coaching messages to a driver on a route in accordance with the present disclosure may be viewed as including a series of operations. These operations include accessing a database of vehicle performance data of a driver's performance on a route, wherein the vehicle performance data includes fuel mileage rates, terrain data, elapsed time, traffic conditions, and weather data; retrieving the drivers most recent past performance data from the database; parsing the performance data into predetermined performance meta-data vectors; obtaining the driver's past coaching statement meta data vectors; obtaining weather data for the driver's current route and parsing the weather data into weather meta-data vectors; obtaining traffic conditions for the driver's route and parsing the traffic conditions into traffic meta-data vectors; and comparing the performance meta-data vectors for the driver, weather meta-data vectors and traffic meta-data vectors to the driver's past coaching statement meta-data vectors to determine positive or negative changes. The method also includes generating new coaching statement meta-data vectors for the driver based on the positive or negative changes; and converting the new coaching statement meta-data vectors to one or more coaching statements for the driver. This exemplary method may further include accessing a coaching statement database containing meta-data vectors for previously utilized coaching statements and comparing the new coaching statement meta-data vectors to the previously utilized coaching meta-data vectors. The coaching statement database meta-data vectors may include fuel usage rates, terrain parameters including hilly, flat, windy, and two lane and multiple lanes. Further, these vectors may also include previously identified safety alerts and concerns identified for the route. The method also may include selecting a coaching statement having the greatest number of matching categories for transmission to the driver.

An embodiment in accordance with the present disclosure may alternatively be viewed as a method for producing coaching messages to a driver on a route. This method includes accessing a database of vehicle performance data of a driver's performance on a route, wherein the vehicle performance data includes fuel mileage rates, terrain data, elapsed time, traffic conditions, and weather data; retrieving the drivers most recent past performance data from the database; retrieving past week's weather data and traffic data for the route; parsing the performance data into predetermined performance meta-data vectors; obtaining the driver's past coaching statement meta data vectors; obtaining weather data for the driver's route and parsing the weather data into weather meta-data vectors; obtaining traffic conditions for the driver's route and parsing the traffic conditions into traffic meta-data vectors; comparing the performance meta-data vectors for the driver, weather meta-data vectors and traffic meta-data vectors to the driver's past coaching statement meta-data vectors to determine positive or negative changes and current values for the vectors; generating new coaching statement meta-data vectors for the driver based on one or more of the positive or negative changes and current values for the meta-data vectors; and converting the new coaching statement meta-data vectors to one or more coaching statements for the driver.

The method may further include accessing a coaching statement database containing meta-data vectors for previously utilized coaching statements and comparing the new coaching statement meta-data vectors to the previously utilized coaching meta-data vectors. In one embodiment the coaching statement database meta-data vectors may include fuel usage rates, terrain parameters including hilly, flat, windy, and two lane and multiple lanes. The method may also include selecting a coaching statement having the greatest number of matching categories for transmission to the driver. In an exemplary embodiment the coaching statement database meta-data vectors include identified safety concerns such as posted route construction notices and warnings.

An exemplary embodiment of an apparatus in accordance with the present disclosure may be viewed as including a hardware processor, and a computer memory holding computer program code executed by the hardware processor. This computer program code is configured to: access a database of vehicle performance data of a driver's performance on a route, wherein the vehicle performance data includes fuel mileage rates, terrain data, elapsed time, traffic conditions, and weather data; retrieve the drivers most recent past performance data from the database; retrieve past week's weather data and traffic data for the route; parse the performance data into predetermined performance meta-data vectors; obtain the driver's past coaching statement meta data vectors; obtain weather data for the driver's route and parse the weather data into weather meta-data vectors; obtain traffic conditions for the driver's route and parse the traffic conditions into traffic meta-data vectors; compare the performance meta-data vectors for the driver, weather meta-data vectors and traffic meta-data vectors to the driver's past coaching statement meta-data vectors to determine positive or negative changes and current values for the vectors; generate new coaching statement meta-data vectors for the driver based on one or more of the positive or negative changes and current values for the meta-data vectors; and convert the new coaching statement meta-data vectors to one or more coaching statements for the driver.

The system may further include the code being configured to access a coaching statement database containing meta-data vectors for previously utilized coaching statements and compare the new coaching statement meta-data vectors to the previously utilized coaching meta-data vectors. The coaching statement database meta-data vectors may include fuel usage rates, terrain parameters including hilly, flat, windy, and two lane and multiple lanes, and the code may be configured to select a coaching statement having the greatest number of matching categories for transmission to the driver. The coaching statement database meta-data vectors may include identified safety concerns such as posted route construction notices and warnings. The foregoing has outlined some of the more pertinent features of the subject matter. These features should be construed to be merely illustrative.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 is a block diagram of a driver measurement and incentive service provider infrastructure in which the techniques of this disclosure may be implemented;

FIG. 2 is a representative client-side (mobile) device that executes an in-vehicle application for teaching, measuring and rewarding a vehicle driver;

FIG. 3 is a process flow of a driver measurement and incentive process for improving vehicle fuel-efficiency;

FIG. 4 illustrates a representative client-side user interface (UI) on a mobile device display;

FIG. 5 illustrates a set of software-based services that execute in a coaching application of this disclosure; and

FIG. 6 illustrates how various algorithms may be used to calculate target variables (e.g., fuel rate, air mass, or the like);

FIG. 7 depicts a process flow of one embodiment of this disclosure, which provides a driver performance measurement system using geohash-based path analysis; and

FIG. 8 depicts a map showing routes taken by first and second drivers and that are processed using MGRS-based analysis according to this disclosure.

FIG. 9 shows a flow diagram of the operations performed to generate a coaching message based on a driver's past performance.

### DETAILED DESCRIPTION

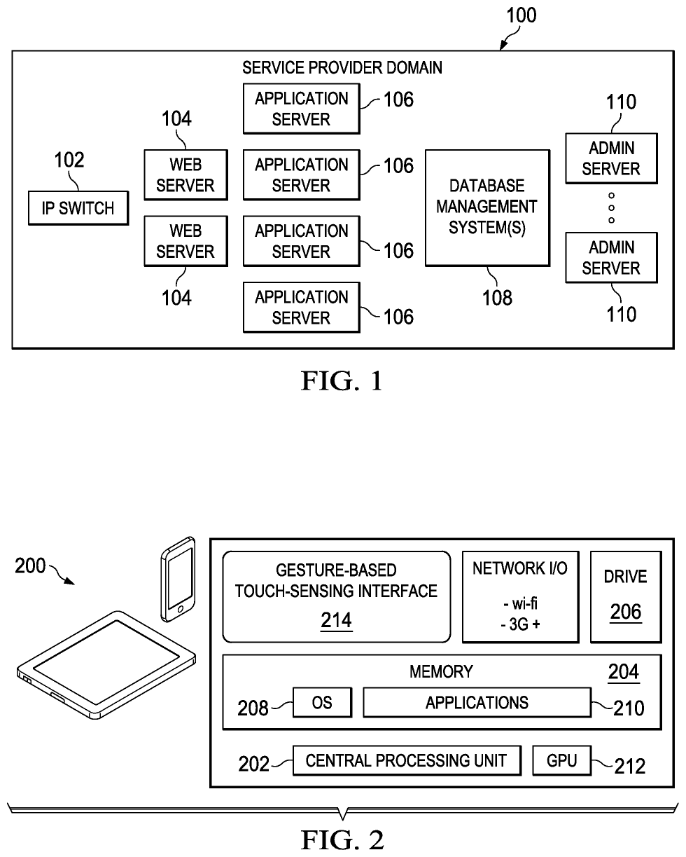

The disclosed method may be practiced in association with a computing infrastructure comprising one or more data processing machines. A representative computing infrastructure provides a driver measurement and incentive service for improving fuel-efficiency. A representative service of this type is PedalCoach™ provided by LinkeDrive of Boston, Mass. This type of service (in whole or in part) may be implemented on or in association with a service provider infrastructure 100 such as seen in FIG. 1.

A representative infrastructure of this type comprises an IP switch 102, a set of one or more web server machines 104, a set of one more application server machines 106, a database management system 108, and a set of one or more administration server machines 110. Without meant to be limiting, a representative technology platform that implements the service comprises machines, systems, sub-systems, applications, databases, interfaces and other computing and telecommunications resources. A representative web server machine comprises commodity hardware, an operating system such as Linux, and a web server. A representative application server machine comprises commodity hardware, Linux, and an application server. The database management system may be implemented as a database management package running on Linux. The infrastructure may include a name service, FTP servers, administrative servers, data collection services, management and reporting servers, other backend servers, load balancing appliances, other switches, and the like. Each machine typically comprises sufficient disk and memory, as well as input and output devices. The software environment on each machine includes a Java virtual machine (JVM) if control programs are written in Java. Generally, the web servers handle incoming requests, and they export web pages (or the like) or other content. The application servers manage the basic functions of the service including, without limitation, business logic.

One or more functions of such a technology platform may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof. More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The front-end of the above-described infrastructure is also representative of a conventional network-accessible web site or web service. This site or service provides a software application that executes in a mobile device to provide the in-vehicle “coaching” functionality of this disclosure, as will be described below. More generally, client (vehicle driver-side) devices access the service provider infrastructure via a network (e.g., the public Internet, a private or dedicated network, or any combination) to provide data, and to retrieve content, including HTML, media players, video content, and other objects. A typical client device is a personal computer, laptop, mobile device, tablet, or the like. A representative mobile device is an Apple iPad® or iPad2, iPad Mini, an Android™-based smartphone or tablet, a Windows®-based smartphone or tablet, or the like. A device of this type typically comprises a CPU (central processing unit), computer memory, such as RAM, and a flash drive. The device software includes an operating system, and generic support applications and utilities.

A representative mobile device is shown in FIG. 2. The device 200 comprises a CPU (central processing unit) 202, such as any Intel- or AMD-based chip, computer memory 204, such as RAM, and a drive 206. The device software includes an operating system 208 (e.g., Apple iOS, Google® Android™, or the like), and generic support applications and utilities 210. The device may also include a graphics processing unit (GPU) 212. In particular, the mobile device also includes a touch-sensing device or interface 214 configured to receive input from a user's touch and to send this information to processor 212. The touch-sensing device typically is a touch screen. The touch-sensing device or interface 214 recognizes touches, as well as the position, motion and magnitude of touches on a touch sensitive surface (gestures). In operation, the touch-sensing device detects and reports the touches to the processor 212, which then interpret the touches in accordance with its programming. The mobile device typically also includes other input/output devices include software-based keyboards, cameras, microphones, and the like.

More generally, the mobile device is any wireless client device, e.g., a cellphone, pager, a personal digital assistant (PDA, e.g., with GPRS NIC), a mobile computer with a smartphone client, or the like. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP.

Thus, a mobile device as used herein is a 3G, 4G, (or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices. The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The client is not limited to a mobile device, as it may be a conventional laptop or other Internet-accessible machine running a web browser or mobile application (app). Content retrieved to the client may be rendered in a browser, within a mobile app, or other rendering engine. The client may also be a telematics device installed in the vehicle. The client also may be integrated into existing in-vehicle devices, such as a fuel mileage gauge in-dash.

### Driver Measurement and Incentive System for Improving Fuel-Efficiency

With the above-described enabling technologies, the following provides additional background. In one embodiment, a vehicle driver is provided with a display interface (e.g., a graphical user interface (GUI)) via the smartphone, tablet, PC, or any telematics or in-vehicle device installed in the vehicle. As will be described, the user interface preferably presents a real-time target to follow to maximize fuel economy and safety, achieved by modulating the accelerator pedal appropriately. Preferably, this target is derived via algorithmic techniques (a set of one or more algorithms) that use data from the following one or more input sources: Engine Control Unit (ECU) data including, without limitation, vehicle speed, engine load, engine speed, fuel rate, mass air flow, and the like, third-party supplied data such as temperature, % grade, time of day, and the like, and other (potentially proprietary) data such as driver history, vehicle history, location target, and the like. The one or more algorithms preferably execute in an application running in the mobile device (or other telematics or i-vehicle device).

In a preferred embodiment, the application runs on a web-connected mobile device, connected to a motor vehicle's engine control unit (ECU), either wirelessly or via cable (e.g., Ethernet, Firewire, or the like). Using the various data sources described, e.g., data received via the Internet or otherwise (i.e. % grade, driver ID, proprietary data, temperature, and the like), data from the mobile device (i.e. GPS location, time of day, or other data), and data from the ECU (mass air flow, fuel rate, rpm, vehicle speed, or other data), a display is rendered by the device to teach a driver how to move the vehicle in the most efficient and safest manner. Generalizing, there may be several data sources that may be used to drive the application. These include: first data, which originates in the vehicle itself; second data, which originates externally from the vehicle and represents one or more local (to the vehicle) environmental condition(s) associated with a current operation (real-time, or near real-time) of the vehicle; and third data that is historical in nature and that associates one or more of the following: this particular driver, this particular vehicle, this particular job, and this particular route. The first data is typically derived from the vehicle ECU system but in general may be any data that originates in the vehicle according to one or more of the following industry standards: SAE (Society of Automotive Engineers International) J1939, SAE J1708, SAE J1587, and SAE J1979. The second data typically is one of: time, temperature, percent grade, wind conditions, weather, altitude (from GPS), hill detection, forward looks at the route grade from topological maps, and the like. The third data typically is specific to the driver, vehicle, job and/or route for which h the calculation is being generated. The third data may not always be available; when third data is available, it is often useful to seed the calculations, as will be described.

In this embodiment, fuel rate is approximated as linearly increasing as the vehicle speed increases with all other factors constant. To generate this line of fuel rates versus speeds, events that fall around an acceleration window (typically zero) are collected and used to determine a fitted first order curve. These collected events can be used to generate an assumption of a fuel rate at a predetermined higher speed (typically 65 miles/hour or its km/hour equivalent). Using one or more of the below-described algorithms, this fuel rate is then used to set a fuel rate limit over a full range of vehicle speeds. As more data is collected, this fuel rate is further refined and updated. Initially, this fuel rate is seeded through remote/local database lookups, and it is refined as more data is collected and confidence of the collected data is high (or at or above a configurable threshold). When external data sources are available, the fuel rate is permitted either to rise or fall as a function, for example, of one or more of: grade %, wind speed and direction, vehicle load, driver habits, and typical route speeds and fuel rates for vehicles of the same type.

Preferably, one or more algorithms as described below operate to a target (fuel rate <diesel> or air mass <spark ignition>) for the driver to follow which varies, for example, according to the difficulty of the mission of the vehicle. Furthermore, preferably a score is presented to the driver such that performance can be measured. In another aspect, an indicator is provided in the form of a display pointer relative to other display indicia that guide or coach the driver regarding the operating characteristics (e.g., an amount of throttle) to apply as the vehicle moves along the route. When utilized, the application improves fuel mileage, reduces safety incidents, and helps fleets retain their best drivers, e.g., by facilitating incentive programs. For example, using the application, the driver is scored and earns or loses “points” based upon their performance against the target. On a periodic basis, a score is used to offer the driver an incentive such as a pre-paid credit card.

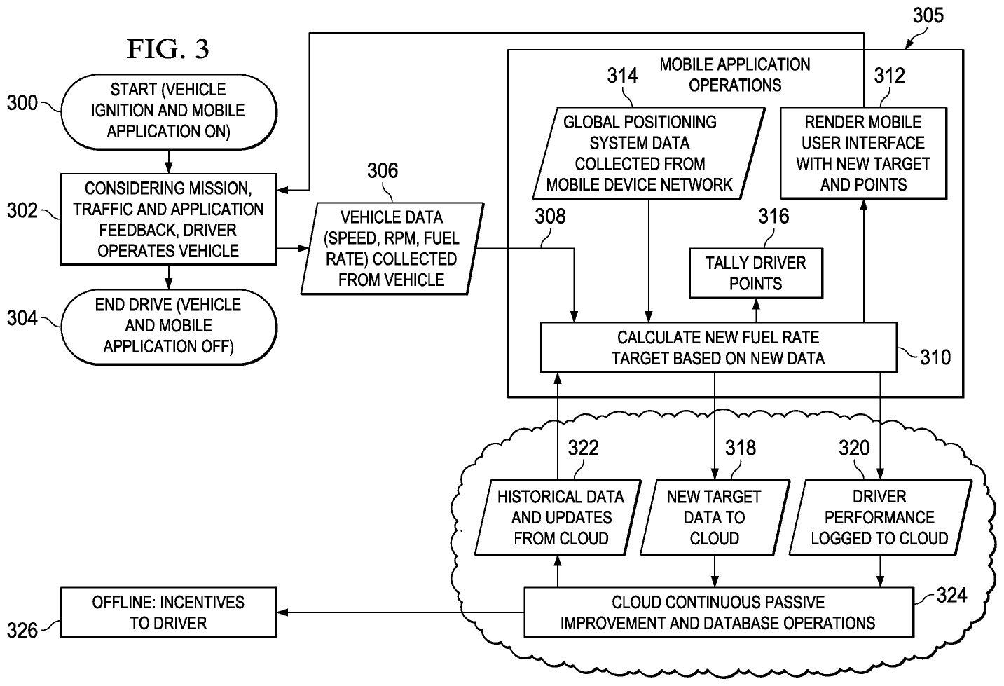

FIG. 3 illustrates a driver performance monitoring technique. Typically, there are a set of mobile device-specific operations, and the mobile device may interface to a service provider infrastructure as necessary. As noted above, the display interface preferably is generated by a software application that provides the described functionality (on the driver side), typically using local display resources in the mobile device (depending on the type of device used). The application may be provided by the service provider, by a third party (e.g., an app store), or it may be integrated (or native to, as original-equipment) with an in-vehicle device.

The following describes the basic operating scenario. Typically, the vehicle is a truck driven by an operator (a driver). This is not a limitation, however, as the techniques herein may be implemented in any type of vehicle (including passenger automobiles, boats, aircraft or other machines) whose fuel efficiency may be monitored and in which visual feedback may be provided to an operator of the vehicle during operation. The vehicle may be being driven remotely by an operator, or the technique may be implemented in a “simulated” driving environment (such as in conjunction with a simulator or training device or system). The techniques herein may also be implemented as a training system or tool within a machine or system, e.g., using test or simulated data for the various inputs, to train vehicle operators for when they get out in real-world situations.

The application described herein is sometimes referred to as a “coach” or “coaching” application, as it is used to train the operator to use the vehicle pedal more efficiently, thereby improving overall vehicle fuel economy. In the typical in-vehicle operating scenario, and with reference to FIG. 3, the operator starts the vehicle (at step 300), which activates the coach application. The vehicle is then operated (step 302) with the assistance of the coaching application (as will be described), which application considers the driving mission and operating conditions, traffic conditions and other data, and provides visual and/or aural feedback to the driver. The vehicle is operated under load on a road. When the drive ends, the vehicle is turned off, and the application is closed (step 304). While in motion, various types of vehicle data such as speed, engine RPM, fuel rate, and the like, are collected (step 306). As noted above, typically this is data from the vehicle electronic unit (ECU) and includes vehicle speed, engine speed, engine load, percent torque, fuel rate, air mass, and the like. This data is pushed to the on-board device (e.g., via wireless or cable) (at step 308). The coach application 305 executes as software (a set of computer program instructions) in the mobile device and performs a number of high level operations as depicted. Its primary functions are calculating a target fuel rate based on various data inputs (at step 310), and using the output of this calculation to control rendering of a new target value on a display interface (at step 312). The target fuel rate (or, in the alternative, air mass) calculation preferably also uses GPS data collected from the mobile device network (at step 314). Typically, data from the device (e.g., GPS location) is pushed to the application wirelessly. The output of the calculation may also be used to generate “points” for a driver who complies with the target fuel rate (at step 316).

The service provider, which may be cloud-based as shown, provides and receives various data, and it provides one or more services. Thus, for example, typically the data from the ECU, as well as the output(s) generated by step 310, are provided to the service provider database (e.g., via mobile data connection) (at step 318). Driver performance driver data captured by the coach application is logged to the service provider (at step 320). Historical data and updates as needed are delivered to the coach application (at step 322). For example, the service provider database typically pushes various types of data, e.g., driver history, driver handicap, location difficulty, vehicle handicap, % grade, time of day, traffic, temperature, and the like, to the application. The service provider preferably also executes a cloud-based driver management process and its associated database operations (at 324), which provides driver incentives or other feedback (at step 326).

In one embodiment, the calculation performed at step 310 works generally as follows. In this example scenario, the calculation is executed on-board the mobile device (and, in particular, the coach application executing thereon) runs a routine against all (or some subset of) inputs to determine what the target (e.g., fuel rate, air mass, and the like) should be for this particular driver, this route, this load, and this vehicle. In the alternative, the calculation (or some portion of it) may be executed in the service provider environment, or elsewhere. The device then receives the target value (or values). Using a display interface, the target value is then rendered, preferably in a graphical manner.

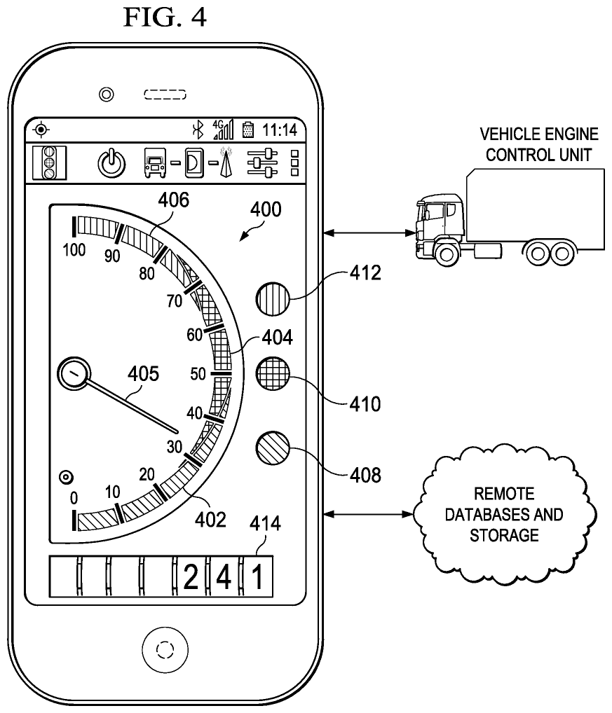

FIG. 4 illustrates a representative display interface 400 for this purpose. The interface may be generated on the mobile device by the coach application, or the outputs from that application may interface to another display application. The display interface 400 is illustrated as a gauge (to be consistent to a standard in-vehicle display format) that includes a set of spaced values as shown. Preferably, the gauge is semi-circular and includes three or more zones, such as green 402, yellow 404 and red 406. A pointer 405 is driver around the gauge based on the results of the calculation (step 310 in FIG. 3). The display preferably is updated continuously, periodically (e.g., every few seconds), or in some combination thereof. There may be particular driving conditions during which the operation of the display is suspended. Additional operator feedback is provided by a set of lights 408, 410 and 412 (e.g., simulated LEDs), which illuminate green, yellow and red, respectively. The interface also preferably includes a running point meter 414, whose value increases provided the driver maintains the pointer within some acceptable range. Thus, data regarding a specific vehicle class (type) is collected and fuel rate versus vehicle speed evaluated (using some empirical data analysis technique). If other data (e.g., information about the particular driver, specific information about the actual vehicle itself, or the like) is available, that other data may be evaluated as well during this process. During this evaluation, preferably zero acceleration events are filtered out. The zero acceleration events correspond to events when the vehicle is not accelerating or decelerating but, rather, travels at constant speed. While there may be lots of small differences over short periods of time, over a large chunk of data these differences tend to average out and the resulting data points represent a function (in effect, “how much fuel does it take to keep the vehicle at a steady speed”). These zero acceleration fuel rate versus vehicle speed data points form a line. The line is described by y=mx+b, where x=speed, and y=fuel rate. This line represents the amount of fuel needed to keep this type of vehicle at speed assuming ideal conditions (no acceleration, driving on a flat and smooth surface, with no wind, a constant load, etc.). This becomes a “baseline” for the vehicle class. Ideally, any fuel rate below this line for a given speed represents “green” on the display interface gauge. Any fuel rate above this line for a given speed represents “yellow and red” on the gauge. If this optimal rate is held, the resulting curve represents the “green/yellow” transition point for the gauge. Preferably, the application gives drivers a little more room at lower speeds than what is represented on the curve. As an example of this approach, a speed point (e.g., 65 MPH) may be selected and the fuel rate capped with the corresponding fuel rate from the baseline. If the driver uses no more than this fuel rate, the vehicle should be able to achieve a gradual acceleration to that speed and then be able to hold it. If more fuel than that is used, the pointer enters the yellow or red zones. Preferably, the calculations may adjust dynamically for events or occurrences (e.g., hills, head winds, or the like) beyond the driver's control. As additional statistically-relevant fuel rate and speed data points (around zero acceleration) are available, the baseline may be recalculated. Typically, it will be desirable to adjust the baseline based on external data (e.g., hill detection, altitude from GPS, forward looks at the route grade from topological maps) and, if available and statistically-significant, historical information (e.g., about the driver, the vehicle, the driver's past history in the vehicle for the particular route, and so forth).

The display pointer in the gauge may be scaled, e.g., by adjusting a weight to be applied to the difference of the actual fuel rate and the recommended/ideal fuel rate and that comparison to a position of the pointer for feedback to the operator. The display pointer may also be scaled to provide different degrees of difficulty based on a proficiency of the driver; thus, as the driver becomes more proficient, it may be desirable to scale the pointer to increase the difficulty (of maintaining the pointer in the green zone) so that the driver's skills may be further improved using the coaching technique. The display interface preferably is rendered by the coach application. In an alternative, the gauge, lights and point meter may be virtual (e.g., projected via a heads-up display, Google Glasses™, or the like. The visual cues may be supplemented (or even replaced) with audible cues, tactile (haptic-based) cues, or some combination(s) thereof. Thus, for example, the mobile device may buzz when the pointer moves out of the green zone, or a signal may be sent to a haptic device embedded in the steering wheel, or the driver's seat, to provide a vibration. Of course, these are merely examples. The display interface may use other display formats and constructs (e.g., linear scales, numerical read-outs, and the like) in lieu of (or to supplement) the gauge.

The display may be augmented to include other information that may be used in the target calculation. The application may be configured to present statistics or other reports to the driver upon given occurrences, such as at key-off. Thus, for example, the application may be configured to provide a driver summary and a driver “leaderboard” so that the driver can determine his or her current status with respect to other drivers.

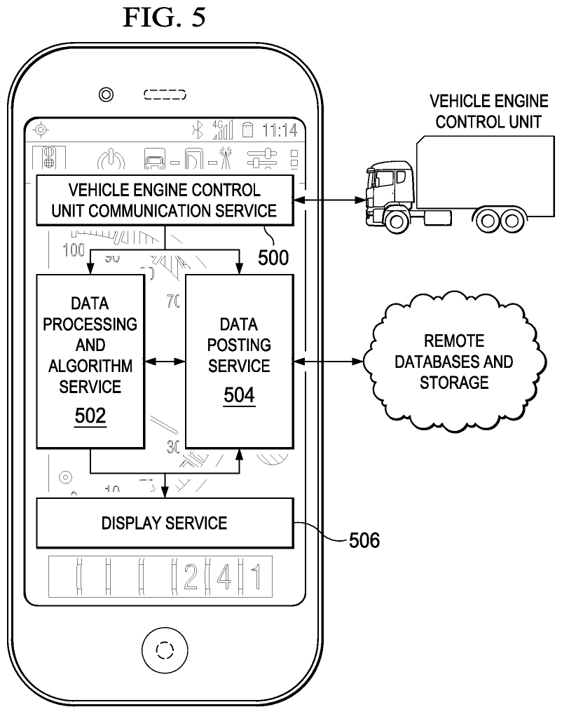

FIG. 5 illustrates a set of software-based services that execute on the mobile device and comprise the coach application. These include a vehicle ECU communication service 500, a data processing and algorithm service 502, a data posting service 504, and a display service 506. ECU communication service provides the vehicle data for the calculation. The data processing and algorithm service 502 performs the calculations to generate the target data, using data supplied by the ECU communication service 500, as well as data provided from the remote databases and storage and forwarded through the data posting service 504. Data posting service 504 also collects driver performance data and posts it to the service provider databases. The display service 506 takes the outputs generated by the service 502 and uses them to drive the displays, in the manner described.

In operation, the target is calculated (based on the inputs), driver performance against the target is measured, points are accumulated, and scoring presented. The service database logs performance data by the vehicle, by the operator, and by location. Preferably, an incentive program is offered to the driver based upon achievement of a minimum score, e.g., as established by a fleet manager.

To use the system in the vehicle, the driver turns on the mobile device and starts the vehicle. A wireless link is established. The driver preferably drives so as to keep the needle in the “green” zone. Points are then awarded, e.g., based on miles driven in the green zone. Miles driven in the yellow zone may be deemed neutral. However, any excursions into the “red” zone preferably lock-out the point-logging for a given time period (e.g., 10 seconds). As indicated, preferably the score is presented as a percentage, calculated as a number of points per number of miles. The score at the end of a measurement period may then result in an incentive bonus based on the fleet and driver targets. The application is turned off as needed or desired.

The subject matter described above thus provides for a software application intended to run on a network-connected mobile device, and connected to receive data from a motor vehicle's engine control unit (ECU). Using the described data sources (or some subset of them), a target value is generated and an indication is rendered by the device to teach a driver how to move the vehicle in a most-efficient manner. In operation, a calculation executed by the application creates a target (fuel rate <diesel> or air mass <spark ignition>) for the driver to follow, and that target preferably varies according to the difficulty of the mission of the vehicle. Furthermore, a score is presented to the driver such that performance can be measured. Financial or other rewards may be offered to the driver periodically on the basis of these scores. Any type of driver incentive program may be used.

The following provides additional details regarding the calculations that are used to drive the display interface. According to this disclosure, a set of algorithms are used for this purpose. As noted above, an underlying assumption is that the fuel rate to maintain a vehicle at a constant speed, with all other factors (grade %, wind speed, load) constant, should linearly increase as speed increases. Each algorithm typically, without limitation, takes in information from the following sources: vehicle Engine Control Unit (ECU) (namely, one or more of: vehicle speed, fuel rate, engine speed, transmission gear value, brake switch, vehicle identification, and component information), the mobile device itself (e.g., GPS Location, GPS Altitude, accelerometer values, and time/date), and external data sources (e.g., temperature, grade %, vehicle information, driver history, and prior fuel limits). As noted above, the ECU data is gathered using communication methods as defined in the industry standard documents which include, but is not limited to: SAE (Society of Automotive Engineers International) J1939, SAE J1708, SAE J1587, and SAE J1979.

Preferably, outputs returned from each algorithm are an instantaneous feedback, typically in the form of a numerical value from 0 to 100% (needle position of the pointer 405) that will reflect a driver's ability to maintain his or her fuel rate (an amount of fuel used per unit time) in an acceptable range determined by the algorithm's fuel rate limit. Along with this feedback, the driver preferably also receives a number of points based upon distance travelled and needle position reference previously. These points are then used as part of the incentive program. Preferably, there are four (4) distinct algorithms that may be used in various ways, as will be explained. These algorithms are referred to herein for convenience as SB, P, G and B. Generally, some combination of the algorithms is used to develop a fuel rate limit based upon the vehicle, driver, payload and driving environment.

Initial (or default) fuel rate limits, prior to acquiring an adequate data set, may be derived using a local and remote database lookup based upon prior vehicle history using vehicle ECU information including VIN, serial number, model, make, and the like. If this information is unavailable or has not been delivered (by the Vehicle ECU) to the mobile device, logged-in fleet or logged-in driver information may be used to generate fuel rate limits. This is considered the initial seeding, whereby the fuel limit is set on those criteria and then further refined using the algorithms listed below. Some “softening” of the fuel limit may be factored into each limit based upon changing short term environmental conditions, e.g. headwind, crosswind, grade changes. During these events, the application typically allows the driver to maintain his or her current speed or maintain current fuel rate, but typically discourages the driver to accelerate during the events. Of course, the application may always make exceptions in the event of hazardous conditions.

The SB algorithm generates a first order polynomial fitted curve based upon fuel rate and vehicle speed based on acceleration value and transmission gear value. This curve is then used to determine the maximum allowable fuel rate at a given speed. The fuel rate limit can be adjusted based upon a difficulty set for the driver. This difficulty adjusts the zero speed intercept of the fuel limit curve. In a preferred embodiment, this algorithm thus takes in driver, company, ECU vehicle information (e.g., VIN, make, and model) to determine a fuel limit for the driver based upon a database query. It then takes in vehicle speed and fuel rate to generate a needle position for the display gauge, and to collect driver points earned, as well as possible driver points.

The P algorithm determines the maximum allowable acceleration that will not increase trip duration, e.g., based upon the EPA's Federal Test Procedures (FTP) Drive Cycle. This calculation leads to an allowable acceleration value over the speed range of the vehicle. Fuel rate limits are then developed by vehicle speed, fuel rate, engine speed and transmission gear value, preferably to generate a simple regression of the vehicle speed and fuel rate. These limits are then used to generate the three (3) distinct driver feedback zones of fuel rate (green, yellow and red). In this algorithm, the fuel rate limits are allowed to change based upon the statistical deviation from previously-collected data to the current collected data. In a preferred embodiment, this algorithm takes in time, vehicle speed, and fuel consumption to determine a fuel limit based upon the acceleration of the vehicle. It then outputs a needle position for the display gauge, and to collect driver points earned, as well as possible driver points.

The G algorithm stores instantaneous events containing vehicle speed, fuel rate and engine speed to finite sized bins based upon their acceleration and transmission gear value. When a statistically-relevant number of bins are filled, a (least-squares) linear regression is developed using the vehicle speed and fuel rate. This regression is then used to determine the top speed fuel rate, which is used to generate a fuel rate limit. Preferably, these fuel rate limits are continuously updated based upon incoming data and drop out of older, less relevant data samples. In a preferred embodiment, this algorithm takes in time, vehicle speed, and fuel consumption to determine a fuel limit based upon acceleration of the vehicle. It then outputs a needle position for the display gauge, and to collect driver points earned, as well as possible driver points. The B algorithm calculates Δspeed/Δfuel rate values based upon the instantaneous events of the vehicle with reference to the current acceleration and transmission gear value. The Δspeed/Δfuel rate value preferably is then cross-referenced to a look up table, either locally or remotely, that stores fuel rate limit curves based upon empirical data analysis of optimum fuel rates for similarly derived Δspeed/Δfuel rate values. During a typical drive, this number typically updates based upon varying environmental conditions, e.g. change in payload, grade change, and wind direction, which will then reference the lookup table to acquire a more appropriate fuel rate limit. In a preferred embodiment, this algorithm takes in time, vehicle speed, and fuel consumption to determine a slope of fuel consumption and vehicle speed, which is then used to determine a fuel limit based upon a database query. It then outputs a needle position for the display gauge, and to collect driver points earned, as well as possible driver points.

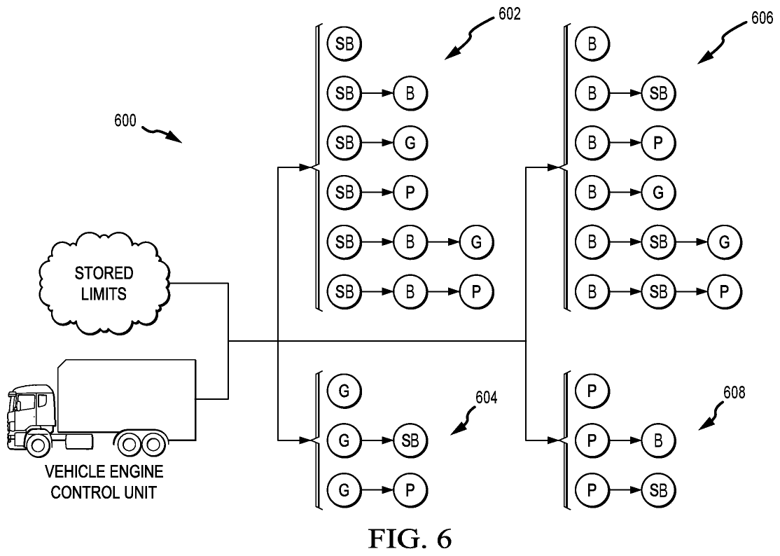

A combination of the described algorithms, or any of them individually, may be used to define the instantaneous fuel limit of the vehicle. A combination of these algorithms preferably is used to generate the optimum fuel rate limit for the vehicle at any given time. FIG. 6 illustrates representative permutations of the algorithms 600. As illustrated, in a first embodiment, as represented at 602, algorithm SB is executed initially individually, or more typically, in association with one or more of the other algorithms as shown. In a second embodiment, as represented at 604, algorithm G is executed initially individually, or in association with the SB or P algorithms. A third embodiment, as represented at 606, involves algorithm B being executed initially, either individually or followed by one or more of the algorithms shown. A fourth embodiment, as represented at 608, involves executing algorithm P initially, either by itself or in association with one of the B and SB algorithms. Thus, as indicated, each of the algorithms may be executed either alone or in some combination. Regardless of which algorithm(s) are used, typically the initial seedings (and thereafter updates) come from the vehicle ECU or from data received to the application from remote data sources, as has been described. The one or more algorithms are executed to further and continuously refine the target (fuel rate or air mass) limit that then drives the pointer and other display elements.

By deploying the coach application, vehicle fleets radically improve operating costs by lowering overall fuel consumption, reducing insurance premiums, and improving driver retention. The coach application easily integrates with existing smartphone, tablet, and telematics solutions. The described approach is readily implemented so little or no additional workflow is required for a fleet to get started and begin saving.

The coach application provides an in-vehicle cab, real-time user display of fuel mileage performance, thereby enabling immediate coaching on actual fuel used versus the fuel needed to get the job done. If the driver follows the display, he or she saves fuel. The coach application automatically measures, detects and calculates, in real-time or substantially real-time, an optimal setting for the vehicle throttle that adapts to the particular driving job, regardless of vehicle class or load. The display is simple to use and provides a common and well-known metaphor that does not distract the driver. By integrating the application into a conventional smartphone or table, hardware costs for the solution are minimal, and the approach is easy to integrate. The cloud-based data services model enables fleet operators and others who use the system easy and secure access to data, reports, leader-boards, or the like and improves analysis, tracking and reporting. The approach enables users to save fuel. Visual (and, optionally, audio and/or haptic) cues provide real-time indicators that coach toward ideal fuel performance regardless of truck class or load. The solution engages and centers driver attention on the things that translate to superior safety performance. A by-product is fewer accidents and lower overall operating costs. With the described approach, both drivers and fleet managers have detailed performance data at their fingertips. The data drives win-win incentive plans and reward programs that help improve driver retention.

The described technique (using the one or more algorithms) adapts to varying roads, loads and other factors that are out of the drivers' control to set an efficient target for the driver to follow. Each trip is scored and logged to feed a monthly or quarterly performance-based incentive program.

### Driver Performance Measurement Based on Geohash-Based Path Analysis

The following describes a variant embodiment. According to another aspect of this disclosure, driving performance comparisons (by and between or among vehicles, drivers, time-of-day, or the like) is enabled by enabling monitored/collected performance data to be overlaid (or otherwise) combined with a path analysis. As used herein, a path refers to a travel path taken by a vehicle. Travel path analysis herein preferably is enabled using geohashes. Geohash is a known geocoding system that encodes a geographic location into a short string of letters and digits. In particular, the geocoding system is a hierarchical spatial data structure that subdivides space into buckets of grid shape. Geohashes provide arbitrary precision; in one type of common geohash (MGRS, as described below), as characters are gradually removed from the end of the code to reduce its size, precision is gradually reduced. As a consequence of the gradual precision degradation, nearby places will often (but not always) present similar prefixes. The longer a shared prefix is, the closer the two places are. With a geohashing API or service (see, http://geohash.org), geographic coordinates can be converted into short URLs that uniquely identify positions on the globe. To obtain the geohash, an address to be geocoded, or latitude and longitude coordinates, are provided (or input to the API or site page), and a geohash is returned. Besides showing the latitude and longitude corresponding to the given geohash, navigating to a geohash also preferably returns an embedded map; the API/service may also provide a GPX file, or transfer the waypoint directly to one or more Global Positioning System (GPS) receivers. GPX (GPS Exchange Format) is an XML schema designed as a common GPS data format for software applications.

Generalizing, a geohash is a location→string mapping. As will be described, by using geohashing, the system of this disclosure has the ability to quantize space from a continuous latitude/longitude-basis to one wherein a single geohash string represents a larger area. According to an embodiment, it is assumed that the above-described performance measuring/monitoring is carried out in-vehicle for two or more users, and that each such tracking also captures the vehicle route, preferably on a continuous basis as the vehicle travels over the route. The continuous travel data for the vehicle is then converted into a finite set of geohashes, e.g., a sequence of MGRS (Military Grade Reference System) grids. MGRS is a geocoordinate standard for locating points on Earth, and it is derived from the Universal Transverse Mercator (UTM) grid system and the Universal Polar Stereographic (UPS) grid system, but uses a different labeling convention. An MGRS grid reference is a point reference system. The first part of an MGRS coordinate is the grid-zone designation. In particular, the 6° wide UTM zones, numbered 1-60, are intersected by latitude bands that are normally 8° high, lettered C-X (omitting I and O). The northmost latitude band, X, is 12° high. In this point reference system, the intersection of a UTM zone and a latitude band is (normally) a 6°×8° polygon called a grid zone, whose designation in MGRS is formed by the zone number (one or two digits—the number for zones 1 to 9 is just a single digit, followed by the latitude band letter (uppercase).

The techniques herein are not limited to MGRS-based grid systems; an alternative is the National Grid system. In still another alternative, a customized geohash may be generated, e.g., by taking given information from a latitude and longitude measure and applying some function, e.g., concatenation. Taking the example of the Prudential Tower in Boston (located at latitude 42.347425, longitude −71.082728), a representative geohash (based on an encoding scheme using up to the first three decimal values and the concatenation function) would have the value “42347-71082.” Any suitable encoding scheme and function may be used to create a custom geohash that associates the location to the string mapping.

After the continuous travel path for the vehicle is converted to a finite set of geohashes (e.g., the sequence of MGRS grids), the driver or vehicle metrics captured (as described above) are assigned to the path, preferably on an individual geohash basis. For example, and without limitation, a particular geohash along the route (path) being analyzed then has associated with a data set, e.g., fuel used, average speed, cruise control use, and the like). Once these data set(s) are generated with respect to the path for the particular driver and/or vehicle, the system saves (stores) the information in a data store having an associated database. The database is accessed via a database management system that enables the data to be queried (searched), with relevant data then returned. According to this disclosure, data sets from two or more drivers or vehicles are captured, associated with geohashes, and the associated data stored for analysis. These geohash-indexed data sets are saved for querying, comparison and analysis.

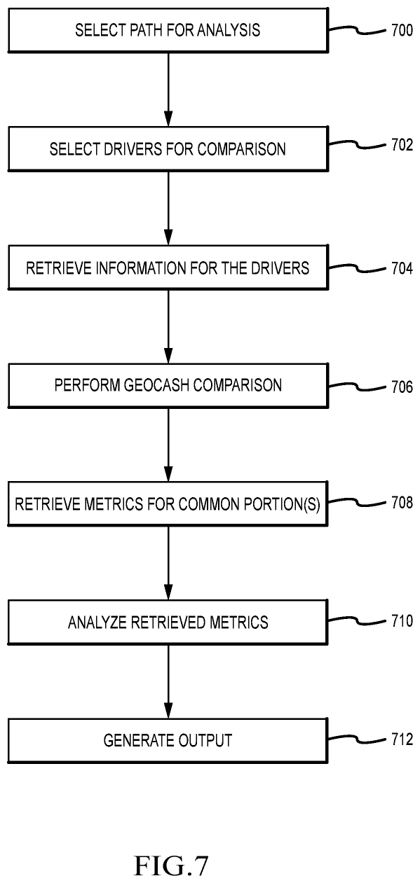

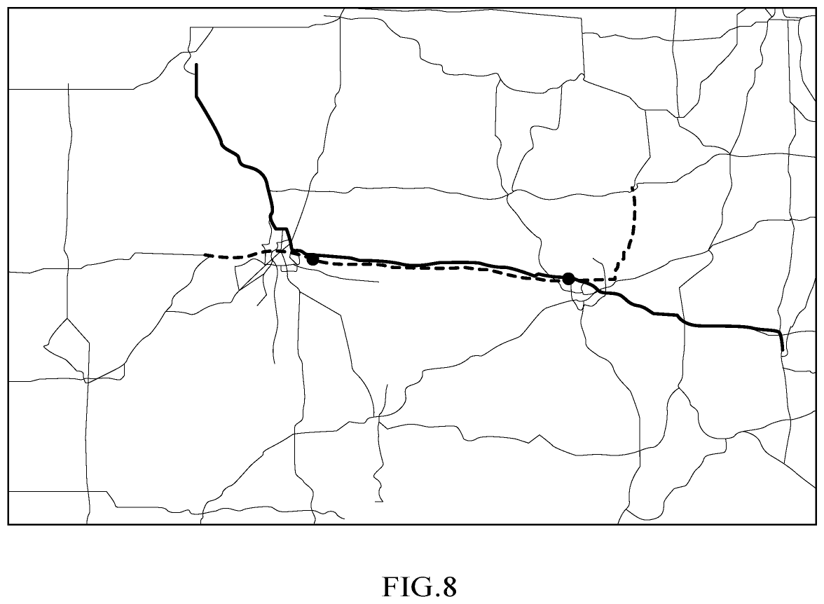

In one embodiment, and with reference to FIG. 7, at step 700, a particular path is selected for analysis. In this example, it is assumed that the path is all or a portion of a vehicle route of interest. At step 702, two or more drivers are selected for comparison. At step 704, the system retrieves the stored information for the drivers. At step 706, a comparison is performed for the relevant geohash data to find one or more portions along the route of interest that are the same. For each common portion identified via the geohash data, the routine continues at step 708 to retrieve the metrics gathered for each driver with respect to the route. The system may filter the data sets if the information in the sets is not identical. At step 710, the retrieved metrics are then compared (analyzed). At step 712, an output of the analysis is provided.

The output may include a visualization, a notification, an alert, or the like, depending on the information required or desired. In this manner, an interested entity (e.g., an employer) can perform specific driver or vehicle performance comparisons. For example, assume there are two (2) trucks, one traveling from Omaha through Kansas City and St. Louis, ending at Evansville. The other truck is traveling from Topeka through Kansas City and St. Louis, ending at Springfield. Using MGRS-based grids, for example, FIG. 8 depicts these routes, with the first route being depicted in solid line, and the second route being depicted in a dashed line. The solid line truck then has MGRS grids (at a one (1) km size), a path: 15TTF6253 (outbound Omaha), 15TTF6252, 15TTF6251, 15SVD0020 (outbound Kansas City), . . . 15SXC9798 (inbound St. Louis), . . . 15SYC5777 (outbound St. Louis towards Evansville), . . . 15SDH4316 (inbound Evansville); the dashed line truck, however, is determined to have a path defined by MGRS grids: 15STD7623 (outboard Topeka), 15STD7723, 15STD7823 15SVD0020 (outboard Kansas City), . . . 15SXC9798 (inbound St. Louis), . . . 16SBJ5204 (outbound St. Louis towards Springfield), . . . 16SBJ7294 (inbound Springfield). Based on a comparison of these geohash data sets (step 706), the following portions are identified as common: 15SVD0020 (outbound Kansas City), 15SXC9798 (inbound St. Louis). Each of these two grids (or other geohash) has performance metrics associated with it for the vehicles/drivers in question. A summation or other computation over the overlapping geohash sequence provides the desired comparative analysis.

Preferably, and based on the computation over the overlapping geohash sequence (or, generalizing, based on some other geohash-based analysis), the system outputs “control” information in the form of signaling that is then delivered (e.g., over-the-air) back to a vehicle and used therein to control an actual in-vehicle system (electronic, electromechanical, etc.) A representative in-vehicle system is a vehicle throttle, a gear system that controls gear selection, a braking system, etc., although these are not limitations, as the particular in-vehicle system that is augmented to respond to control signaling of this type (generated by the platform) may vary depending on the application and the nature of the feedback that is returned back to the vehicle. The data set(s) described above and the results of applying computations to the performance metrics and their associated geohashing data may be analyzed using a web-based UI, programmatically via an API, or otherwise.

Path analytics as described herein do not require data be collected from actual vehicles operating over the relevant paths. In an alternative embodiment, the data may be provided to (i.e., received at) the analytics system from a third party data source (e.g., Waze®). The third party data source, in turn, may collect such information in any manner including, without limitation, crowdsourcing. As a further variant, the data collected need not be based entirely on movement of a vehicle. Thus, one or more performance metrics may also be collected (obtained) with respect to a vehicle-at-rest (idling).

The performance metrics data provided to the analysis system and used in accordance with the techniques herein may be simulated data (i.e., based on a simulation of vehicle activity). Thus, in this embodiment, the data analytics are carried out with respect to a data set of performance metrics derived from simulated vehicle movement/activity. The output of the simulation may then be “returned” to the simulated vehicle in the form of a control signal (as described above in the real-world case), with the simulation then augmented to account for inclusion of the control signal.

The technique herein, namely, receiving performance metrics (real, simulated, crowdsourced, etc.), associating the metrics with buckets of geospatial data, and then using that data for comparative analysis, may also create a computational model. A representative model is a machine learning (ML) model, that can then be used for training and other control purposes, as previously described.

Performance metrics (whether real, simulated, sourced from configured vehicles, crowdsourced, etc.) may be associated with buckets of geospatial data and still further constrained by other factors, e.g., time, time-of-day, vehicle speed, etc., and combinations thereof. In this manner, the control signaling generated by applying computation analysis to such data sets may be even more finely-grained.

The notion of “performance” with respect to “performance metrics” is not intended to be limiting to actual driving performance data, as previously noted. Performance as used herein relates to any type of activity that may be captured with respect to vehicle systems or operation, whether real or simulated.

The techniques herein are not limited to vehicles that are internal combustion engine-based vehicles. The approach of capturing/receiving performance (activity) metrics, associating that data with bucket-based geospatial data, performing analytics on that bucketized data, and then using the results for in-vehicle control purposes, etc., may also apply to hybrid vehicles and electric vehicles.

The activity data received with respect to a set of vehicles may be model-specific, thereby enabling the system to perform analytics and provide model-specific control signaling. As noted above, the techniques herein do not require on obtaining performance metrics (or, more generally, activity data) from in-vehicle based applications (e.g., the LinkeDrive PedalCoach), although this is a useful source for that data. Rather, the techniques herein typically are implemented as back-end operations that receive the performance measurements (whether actual or simulated, etc.). In the usual scenario, computing processes running in the back-end (e.g., cloud-based) computing system receives that information and establishes performance measurement thresholds. Using the techniques herein and, in particular, by applying computations over bucket-based geospatial data, much more useful output data is obtained, and these computations are carried out more efficiently (computational-wise, and storage-wise) given that the data sets are in effect compressed by being encoded according to the bucket-based approach. The back-end server can then compute one or more control parameters for a given route within a given bucket, and such control information is then returned back to the vehicle for real-time or after-the-fact (learned) control. The server calculations result in performance measurement target values that are known to be “good” for the given location, time, time-of-day, speed, vehicle model, etc. In one embodiment, the control signaling is sent back to an application in a mobile device carried in the vehicle, or even directly to some internal control mechanism (e.g., an ECU). The mobile device application may control the ECU (or other in-vehicle system) directly, or provide information to the driver to enable the driver to provide such control. While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

Coaching messages are actual messages generated by fleet managers, other drivers and human driving coaches. These coaching messages, provided to drivers in several fleets in accordance with the above methodology, have been collected and analyzed for a substantial period of time to date. Using natural language processing, each of these messages is converted into something that computers have a much easier time comparing and working on. Thus each message is parsed into meta-data and categorized based on actual driver performance and the actual coaching messages.

A more detailed explanation of the coaching of an exemplary driver in accordance with the present disclosure is explained. In an exemplary embodiment, the coaching messages in accordance with the present disclosure utilize telematics measurement such as information obtained by the sensors above described such as the driver's performance data from the last trip, the weather, traffic, geography, and prior performance measurements. In addition, prior coaching messages provided to the driver are also considered.

For example, if a coaching message last week was sent to the driver: “Another challenging week dealing with an abundance of hills and mountains! Great job pushing the boundaries on fuel efficiency!”. This prior coaching message is retrieved from the history database and first parsed into its meta-data. Then the meta-data is compared to the current driver's assigned route and schedule, climate conditions, traffic patterns etc., stored in the database.

The exemplary message above may have meta data as follows:

“Hills”: yes.

“Hills_last_week”: yes

“fuel_efficiency: good . . .

If any driver's past week satisfies these conditions, the above example message first shown above would apply for the current week.

During a given driver's route this week, he or she may have to face hilly terrain only one day. Thus the threshold can be established, for example, that if they drove in the hills 3+ days during a week, that indicates “a week of hilly driving.” A similar quantification is made regarding fuel efficiency.

In the coaching methodology in this disclosure we do not care about the actual number in miles per gallon. Only that it meets a finite set of predetermined options, such as: poor, ok, good, great, or exceptional. In this exemplary case, if the aggregate fuel efficiency for a particular route, as determined from historical data in the database ranges from 5 mpg to 15 mpg, this would equate to poor=<5 mpg; ok=5-7 mpg; good=8-10 mpg; great=11-13 mpg; and exceptional >13 mpg.

For another category, such as traffic, the threshold may simply be binary, e.g. a yes or no, or it may be a value based on the amount of time or distance traveled that the driver had to spend in traffic.

For terrain, such as hilly, flat, or mountainous, a meta-data value such as 2, 1 or 3, respectively may be given depending on the particular geographic features historically associated with the route.

For the first driver mentioned above, the meta data performance comparison is zero, hence the coaching message completely makes sense as the driver experienced everything during the week that the coaching message tasks about; i.e. a perfect match.

As another example, for a second driver who had only one hilly day, had great fuel efficiency 9.1 mpg and nothing else, the meta-data would look like: [Hills: NO; Fuel_efficiency: great; “Traffic: NO. As a result, the message quoted above, i.e. “Another challenging week dealing with an abundance of hills and mountains! Great job pushing the boundaries on fuel efficiency!”, would not be used as the meta-data differences is not zero. The idea here is to find the coaching messages that are most closely related to the actual experiences and performance measurements of the driver

The vectors of meta-data for a given driver are compared to the list of meta-data vectors of coaching messages previously stored in the database based on prior driver activity. The goal is to find coaching messages where the distance between the coaching message meta data vector to the actual driver performance for that vector is zero. When this is found, that coaching message is appropriate for the driver that week.

This means that the meta-data for the chosen coaching messages is always a subset of the meta-data for the actual driver for the previous cycle. This way no message will be chosen that does not reflect actual experiences for the driver. Coaching messages may omit aspects of driver experiences (hence the subset criteria, or characterization), however the will never be actually “wrong”. For example, the message chosen would not include a comment to the driver on hills when in fact there were no hills during the driver's prior weeks.

In essence, the process in accordance with the present disclosure strives to match the highest message specificity. if we imagine two more coaching messages:

“good job with the fuel”

“Another tough week battling hills and traffic. Great job keeping fuel efficiency high even in these adverse conditions. Thanks for your great work!”

Now compare the first driver's efforts in the immediately prior week, we find that the second message has the highest number of categories with matches. (Hills, Hills last week, Fuel efficiency, and Traffic, even though all three messages will have a distance of zero from the actual driver performance data.

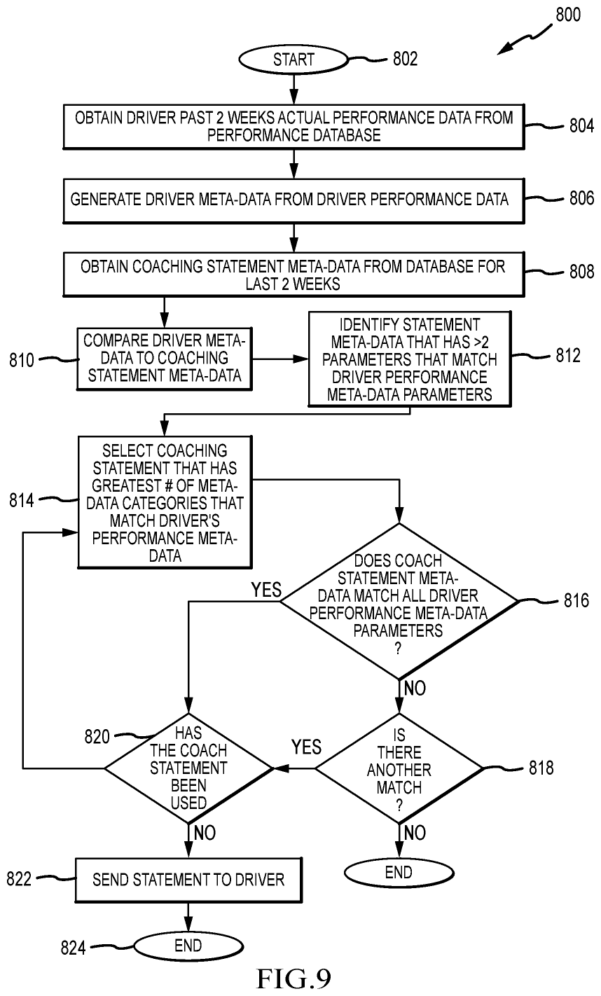

A process flow diagram of one exemplary embodiment of coaching statement generation 800 in accordance with the present disclosure is outlined in FIG. 9. In this exemplary process the vehicle driver enters his vehicle cab, starts his vehicle and turns on his mobile device in accordance with the procedure described above with reference to FIG. 3. The process thereafter recognizes the driver in operation 802. Control then transfers to operation 804.

In operation 804, the computer is queried to retrieve the driver's two past week's actual performance data from the vehicle performance database. The driver may have driven two or more different vehicles during that time period, but the actual performance data placed in the database during those weeks is associated both with that particular driver and also associated with the particular vehicles involved. Hence different parameters may have been stored based in the individual vehicle performance history. For example, fuel performance meta-data may differ for the different vehicles. In such case, an average may in fact be retrieved. Note that the system is calculating the performance measurement and driver experience meta-data on a per driver basis, irrespective of the vehicle in which the data was generated. The driver can drive a different tractor every day. As soon as the driver logs into PedalCoach, for example, that data for that period while they are logged in is tagged with the driver's name and not with the tractor identifier. Control then transfers to operation 806.

In operation 806, the retrieved driver performance data during the previous two week periods are each parsed into performance meta-data, values and categories for each week. Control then transfers to operation 808.

In operation 808, the process reaches out to the coaching statement database and retrieves the coaching statements and associated meta-data therefor that had been presented to the driver at the end of each of the prior two weeks. Control then transfers to compare operation 810.

In compare operation 810, the driver performance meta data and prior coaching statement meta-data are compared to determine matching combinations of driver performance meta-data and prior coaching statement meta-data. Control then transfers to operation 812.

In operation 812, the coaching statement meta-data for the most recent week is analyzed to determine whether there are greater than two parameters that match driver performance meta-data parameters for the most recent week. The coaching statement meta-data for the previous week is also analyzed to determine whether there are greater than two parameters that match driver performance meta-data parameters for that previous week. Control then transfers to operation 814.

Operation 814 selects, from the identified coaching statements identified in operation 812, that coaching statement that has the greatest number of meta-data categories that match the driver's performance meta-data during each of the prior two weeks. Control then transfers to query operation 815.

In query operation 815, the question is asked whether there are any coaching statement matches. If there are matches, control transfers to query operation 816. If there are no coaching statement matches at all, control transfers to end operation 824 without a coaching statement being sent to the driver. Alternatively, a “catch all” type coaching message from a set of generic messages may be chosen for transmission to the driver in this situation. For example, looking at fuel efficiency only, one of the following could be sent to the driver: “good job with fuel efficiency;” “Thank you very much for a great job with fuel efficiency”; or “Whoa, what a fantastic job with fuel efficiency”. Query operation 816 asks whether the identified coaching statement meta-data in operation 814 matches all driver performance meta-data parameters. If the answer in operation 816 is no, control transfers to query operation 818. If the answer in query operation 816 is yes, control transfers to query operation 820.

Query operation 818 asks whether there is another match identified in operation 814. If there is, then that another coaching statement is selected and control transfers to operation 820.

On the other hand, if there is no match, then control transfers back to operation 814 where the coaching statements are again compared to identify another coaching statement in which the next greatest number of meta-data categories match the greatest number of driver's performance meta data categories and values. Control then again transfers to query operation 816 where this next coaching statement meta-data match is evaluated. If there is a match, control transfers to operation 820. If not, each of the process operations 814, 815 816, and 818 are repeated until there are no further matching statements with meta-data categories that match any of the driver's performance meta data. In such event where there are NO matches, control transfers to end operation 824.

In query operation 820, the question is asked whether the identified and selected coaching statement has already been used with the driver. If yes, then control transfers back to operation 814 to determine a different coaching statement from those identified in operation 808. If the answer in query operation 820 is no, the statement has not been utilized before, then control transfers to operation 822 where the identified and selected coaching statement is sent to the driver. Control then transfers to end operation 824. It should be understood that while coaching messages eventually will be re-used, as the number of them is finite, the meta-data arrangement could be changed. Thus from a human psychology point of view the same exact message repeated is not received as well as different variations with the same meaning.

While given components of the system have been described separately, one of ordinary skill will appreciate that some of the functions may be combined or shared in given instructions, program sequences, code portions, and the like.

What is claimed is as follows:

1. A method for producing coaching messages to a driver on a route comprising:
accessing a database of vehicle performance data of a driver's performance on a route, wherein the vehicle performance data includes fuel mileage rates, terrain data, elapsed time, traffic conditions, and weather data;
retrieving the drivers most recent past performance data from the database;
parsing the performance data into predetermined performance meta-data vectors;
obtaining the driver's past coaching statement meta data vectors;
obtaining weather data for the driver's current route and parsing the weather data into weather meta-data vectors;
obtaining traffic conditions for the driver's route and parsing the traffic conditions into traffic meta-data vectors;
comparing the performance meta-data vectors for the driver, weather meta-data vectors and traffic meta-data vectors to the driver's past coaching statement meta-data vectors to determine positive or negative changes;
generating new coaching statement meta-data vectors for the driver based on the positive or negative changes; and
converting the new coaching statement meta-data vectors to one or more coaching statements for the driver.

2. The method according to claim 1 further comprising accessing a coaching statement database containing meta-data vectors for previously utilized coaching statements and comparing the new coaching statement meta-data vectors to the previously utilized coaching meta-data vectors.

3. The method according to claim 2 wherein the coaching statement database meta-data vectors include fuel usage rates, terrain parameters including hilly, flat, windy, and two lane and multiple lanes.

4. The method according to claim 3 further comprising selecting a coaching statement having the greatest number of matching categories for transmission to the driver.

5. A method for producing coaching messages to a driver on a route comprising:
accessing a database of vehicle performance data of a driver's performance on a route, wherein the vehicle performance data includes fuel mileage rates, terrain data, elapsed time, traffic conditions, and weather data;
retrieving the drivers most recent past performance data from the database;
retrieving past week's weather data and traffic data for the route;
parsing the performance data into predetermined performance meta-data vectors;
obtaining the driver's past coaching statement meta data vectors;
obtaining weather data for the driver's route and parsing the weather data into weather meta-data vectors;
obtaining traffic conditions for the driver's route and parsing the traffic conditions into traffic meta-data vectors;
comparing the performance meta-data vectors for the driver, weather meta-data vectors and traffic meta-data vectors to the driver's past coaching statement meta-data vectors to determine positive or negative changes and current values for the vectors;
generating new coaching statement meta-data vectors for the driver based on one or more of the positive or negative changes and current values for the meta-data vectors; and
converting the new coaching statement meta-data vectors to one or more coaching statements for the driver.

6. The method according to claim 5 further comprising accessing a coaching statement database containing meta-data vectors for previously utilized coaching statements and comparing the new coaching statement meta-data vectors to the previously utilized coaching meta-data vectors.

7. The method according to claim 6 wherein the coaching statement database meta-data vectors include fuel usage rates, terrain parameters including hilly, flat, windy, and two lane and multiple lanes.

8. The method according to claim 7 further comprising selecting a coaching statement having the greatest number of matching categories for transmission to the driver.

9. The method according to claim 6 wherein the coaching statement database meta-data vectors include identified safety concerns.

10. The method according to claim 9 wherein the identified safety concerns include posted route construction notices and warnings.

11. An apparatus comprising:
a hardware processor, and a computer memory holding computer program code executed by the hardware processor, wherein the computer program code is configured to:
access a database of vehicle performance data of a driver's performance on a route, wherein the vehicle performance data includes fuel mileage rates, terrain data, elapsed time, traffic conditions, and weather data;
retrieve the drivers most recent past performance data from the database;
retrieve past week's weather data and traffic data for the route;
parse the performance data into predetermined performance meta-data vectors;
obtain the driver's past coaching statement meta data vectors;
obtain weather data for the driver's route and parsing the weather data into weather meta-data vectors;
obtain traffic conditions for the driver's route and parsing the traffic conditions into traffic meta-data vectors;
compare the performance meta-data vectors for the driver, weather meta-data vectors and traffic meta-data vectors to the driver's past coaching statement meta-data vectors to determine positive or negative changes and current values for the vectors;
generate new coaching statement meta-data vectors for the driver based on one or more of the positive or negative changes and current values for the meta-data vectors; and
convert the new coaching statement meta-data vectors to one or more coaching statements for the driver.

12. The system according to claim 11 further comprising the code being configured to access a coaching statement database containing meta-data vectors for previously utilized coaching statements and compare the new coaching statement meta-data vectors to the previously utilized coaching meta-data vectors.

13. The system according to claim 12 wherein the coaching statement database meta-data vectors include fuel usage rates, terrain parameters including hilly, flat, windy, and two lane and multiple lanes.

14. The system according to claim 13 further comprising the code being configured to select a coaching statement having the greatest number of matching categories for transmission to the driver.

15. The system according to claim 12 wherein the coaching statement database meta-data vectors include identified safety concerns.

16. The method according to claim 15 wherein the identified safety concerns include posted route construction notices and warnings.
